(19) United States
(12) Patent Application Publication
(10) Pub. No.: US 2009/0073223 A1
(43) Pub. Date: Mar. 19, 2009

(54) Inkjet image forming apparatus having a nozzle unit and method of using the same

(76) Inventor: Su-Min Lim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/289,879

(22) Filed: Nov. 6, 2008

Related U.S. Application Data
(62) Division of application No. 11/179,647, filed on Jul. 13, 2005.

(30) Foreign Application Priority Data
Nov. 11, 2004 (KR) 2004-91906

(51) Int. Cl. B41J 2/165

(52) U.S. Cl. 347/33

(57) ABSTRACT

Provided is an inkjet image forming apparatus having a nozzle unit cleaning and capping means and a method of cleaning and capping the nozzle unit. The inkjet image forming apparatus includes an inkjet head including a nozzle unit with a length corresponding to a width of a sheet of paper, and a body having an opening formed at one side thereof, wherein the inkjet head slides through the opening in a main scanning direction to be mounted in or removed from the body. The nozzle unit is cleaned by a wiper and capped when the inkjet head is removed from the body.

### CROSS-REFERENCE TO RELATED APPLICATION

This application is a division of U.S. patent application Ser. No. 11/179,647, filed on Jul. 13, 2005, which claims the benefit under 35 U.S.C. §119(a) of Korean Patent Application No. 10-2004-0091906, filed on Nov. 11, 2004 in the Korean Intellectual Property Office, the entire disclosures both of said applications being hereby incorporated by reference.

### BACKGROUND OF THE INVENTION

1. Field of the Invention

The present invention relates to an inkjet image forming apparatus. More particularly, the present invention relates to an inkjet image forming apparatus employing an inkjet head that includes a nozzle unit with a length corresponding to a paper width.

2. Description of the Related Art

In general, inkjet image forming apparatuses form an image by ejecting ink from a shuttling inkjet head that is spaced a predetermined distance from a top surface of a sheet of paper and reciprocates in a direction orthogonal to a sheet feed direction. In recent years, attempts have been made to realize a high speed printing apparatus using a line printing inkjet head that includes a nozzle unit having a length in a main scanning direction corresponding to the width of a sheet of paper, instead of an inkjet head that reciprocates in a transverse direction of the width of a sheet of paper. In such inkjet image forming apparatuses, the line printing inkjet head is fixed and only the sheet of paper is moved. Accordingly, the driving unit of the inkjet image forming apparatuses is simple and a high speed printing can be realized.

U.S. Pat. No. 6,637,856 discloses an inkjet printer employing a line printing head. In the disclosed printer, a top cover is opened and the line printing head is vertically mounted from above the body of the printer. Since the line printing head has a length greater than that of a shuttling printing head, it is difficult to vertically mount and dismount the line printing head to and from the body. Further, while the line printing head is mounted in or removed from the body, the line printing head may collide with the body and may be damaged. The top cover should be larger than a projected area of the line printing head in a vertical direction. Accordingly, when considering the additional space occupied by the opened top cover, the area occupied by the installed image forming apparatus increases.

### SUMMARY OF THE INVENTION

The present invention provides an inkjet image forming apparatus to which or from which an inkjet head can be easily mounted or dismounted.

According to an aspect of the present invention, there is provided an inkjet image forming apparatus comprising an inkjet head comprising a nozzle unit with a length corresponding to a width of a sheet of paper; and a body having an opening formed at one side thereof, wherein the inkjet head slides through the opening in a main scanning direction to be mounted in or removed from the body.

The inkjet image forming apparatus may further comprise: first guide parts formed on the inkjet head in the main scanning direction; and second guide parts extending from the body in the main scanning direction and coupled to the first guide parts to guide the inkjet head.

The inkjet image forming apparatus may further comprise a door selectively opening and closing.

The inkjet image forming apparatus may further comprise a wiping member disposed on the body and contacting a nozzle unit of the inkjet head when the inkjet head is mounted in or removed from the body to clean the nozzle unit.

The inkjet image forming apparatus may further comprise a cam member extending in the main scanning direction and having slanted cam parts; a cap member pushed by the inkjet head to slide in the main scanning direction when the inkjet head is mounted in the body, and guided by the cam parts to cap the nozzle unit of the inkjet head; and an elastic member providing an elastic force to the cap member in a direction where the cap member contacts the inkjet head.

The inkjet image forming apparatus may further comprise an uncapping unit for sliding the cam member and moving the cap member to an uncapping position to perform a printing operation in a state where the inkjet head is mounted in the body.

The inkjet image forming apparatus may further comprise an image input unit installed on top of the body for reading an image from a document. The image input unit may be a flat-bed type image input unit or a document feeding type image input unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a body and an inkjet head of an inkjet image forming apparatus according to an embodiment of the present invention;

FIG. 2 is a perspective view of the inkjet image forming apparatus shown in FIG. 1, illustrating that the inkjet head is inserted into the body;

FIG. 3 is a cross-sectional view of the inkjet image forming apparatus taken along line I-I′ of FIG. 1;

FIG. 4 is a schematic view of an example of a nozzle unit according to an embodiment of the present invention;

FIG. 5 is a perspective view of an embodiment of a wiping member;

FIG. 6 is a perspective view of another embodiment of the wiping member;

FIG. 7 is a perspective view illustrating an uncapping operation according to an embodiment of the present invention;

FIG. 8 is a perspective view illustrating a capping operation according to an embodiment of the present invention;

FIG. 9 is a perspective view illustrating the operation of an uncapping unit;

FIG. 10 is a perspective view of an inkjet image forming apparatus employing a flat-bed type image input unit according to an embodiment of the present invention; and

FIG. 11 is a perspective view of an inkjet image forming apparatus employing a document feeding type image input unit according to an embodiment of the present invention.

Throughout the drawings, is should be understood that like reference numerals refer to like features, structures and elements.

### DETAILED DESCRIPTION OF EXEMPLARY EMBODIMENTS

The present invention will now be described more fully with reference to the accompanying drawings, in which preferred embodiments of the invention are shown.

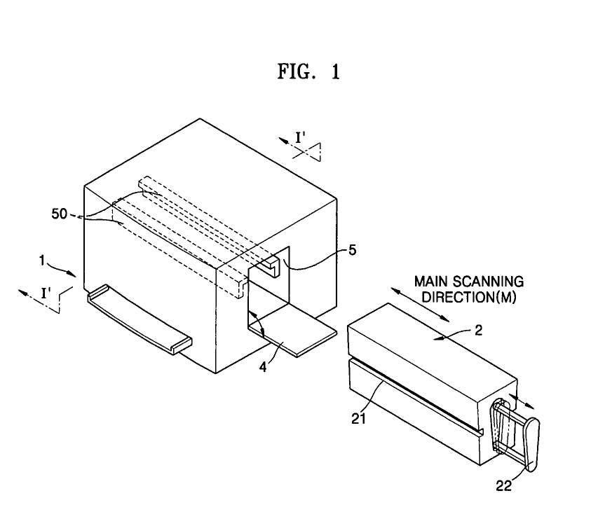

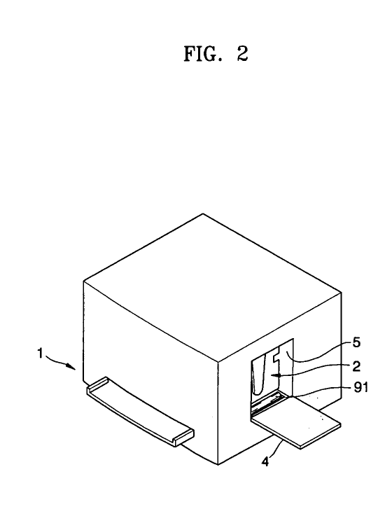

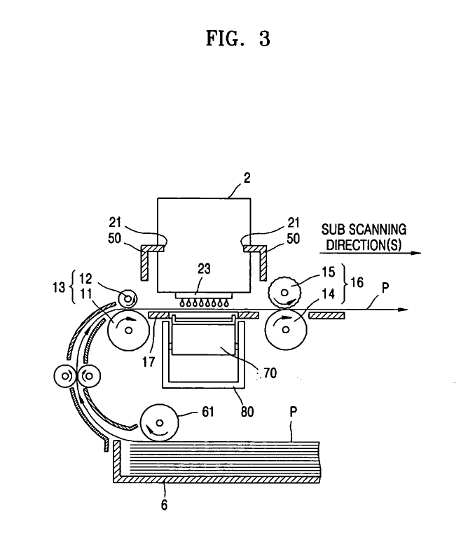

FIGS. 1 and 2 are perspective views of an inkjet image forming apparatus according to an embodiment of the present invention. FIG. 3 is a cross-sectional view of the inkjet image forming apparatus taken along line I-I′ of FIG. 1.

Referring to FIGS. 1 through 3, an image forming apparatus comprises a body 1 and an inkjet head 2. The body 1 comprises a transport unit 13, as shown in FIG. 3, that is disposed at an inlet side of the inkjet head 2 and transports a sheet of paper P, and a discharge unit 16 disposed at an outlet side of the inkjet head 2 and discharging the sheet of paper P on which printing is completed. In the present embodiment, the transport unit 13 preferably comprises a feed roller 11 and an idle roller 12 elastically engaging the feed roller 11. The discharge unit 16 comprises a discharge roller 14 and a star wheel 15 engaging the discharge roller 14 to allow the star wheel 15 to contact a top surface of the sheet of paper P. A support member 17 is disposed under the inkjet head 2 and supports a rear surface of the sheet of paper P. The inkjet head 2 is disposed so that a nozzle unit 23 and the sheet of paper P can maintain a predetermined distance therebetween, for example, a distance of approximately 0.5 to 2.5 mm.

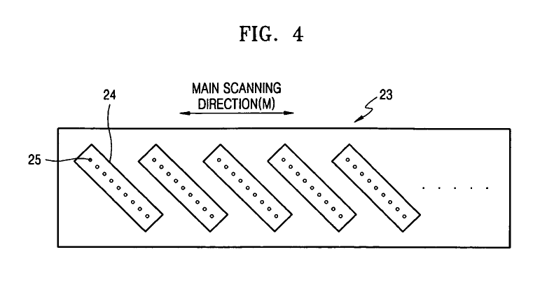

In the present embodiment, the inkjet head 2 is a line printing inkjet head that prints an image by ejecting at a fixed position ink onto the sheet of paper P. The inkjet head 2 comprises the nozzle unit 23, which has a length in a main scanning direction M corresponding to a width of the sheet of paper P. Referring to FIG. 4, the nozzle unit 23 comprises a plurality of nozzle plates 24 each of which has a plurality of aligned nozzles 25. The oblique nozzle plates 24 are arranged in the main scanning direction M. The nozzle unit 23 illustrated in FIG. 4 is exemplary, and the scope of the present invention is not limited thereto. An interval between adjacent nozzles 25 in the main scanning direction M is a measurement of the resolution of the inkjet head 2. The inkjet head 2 further comprises a chamber (not shown) communicating with each nozzle and having an ejection means (such as a piezo element or a heater) for providing pressure for the ejection of ink, and a fluid path (not shown) through which ink is supplied to the chamber. The chamber, the ejection means, and the fluid path are well known to one of ordinary skill in the art, and thus a detailed explanation thereof has been omitted.

A pickup roller 61 picks up sheets of paper P stacked on a cassette 6 one by one and supplies the same to the transport unit 13. The transport unit 13 transports the picked sheet of paper P in a sub scanning direction S at a predetermined printing speed. The inkjet head 2 prints an image by ejecting at a fixed position ink onto a top surface of the sheet of paper P. The sheet of paper P on which printing is completed is discharged by the discharge unit 16. Here, the star wheel 15 point-contacts the top surface of the sheet of paper P to prevent the ink, which has been ejected to the top surface of the sheet of paper P but might not have dried yet, from being smeared or smudged. In this way, the image forming apparatus employing the line printing inkjet head 2 can print at a speed of 30 or more sheets per minute.

To refill ink, replace the printing head, or handle a paper jam, the inkjet head 2 needs to be removed from the body 1. Further, after measures are taken for the above purposes, the inkjet head 2 needs to be mounted in the body 1 again. The body 1 has an opening 5 formed at one side thereof in the main scanning direction M. The inkjet head 2 slides through the opening 5 in the main scanning direction M to be mounted in or removed from the body 1. First guide parts 21 are disposed on the inkjet head 2 and second guide parts 50 are disposed on the body 1 to guide the sliding inkjet head 2 in the main scanning direction M. In the present embodiment, the first guide parts 21 having a groove shape are formed in the main scanning direction M on both sides of the inkjet head 2 that are formed in the sub scanning direction S. The second guide parts 50 coupled to the first guide parts 21 are disposed on the body 1. The inkjet head 2 is guided by the first and second guide parts 21 and 50 to slide in the main scanning direction M. The second guide parts 50 are positioned so that the nozzle unit 23 of the inkjet head 2 and the top surface of the sheet of paper P supported by the support member 17 can maintain a predetermined distance therebetween. A handle 22 is disposed at one side of the inkjet head 2 in the main scanning direction M. A user holds the handle 22 and mounts the inkjet head 2 in the body 1 or removes the inkjet head 2 from the body 1. The body 1 may further include a door 4 covering and uncovering the opening 5. The door 4 is preferably greater than a project area of the inkjet head 2 in the main scanning direction M.

According to the image forming apparatus described above, since the inkjet head 2 slides in the main scanning direction M to be mounted in or removed from the body 1, the inkjet head 2 can more easily be inserted into or removed from the body than a conventional one. Furthermore, once the inkjet head 2 is mounted in the body 1, the interval between the nozzle unit 23 of the inkjet head 2 and the sheet of paper P can be maintained by means of the first guide parts 21 and the second guide parts 50.

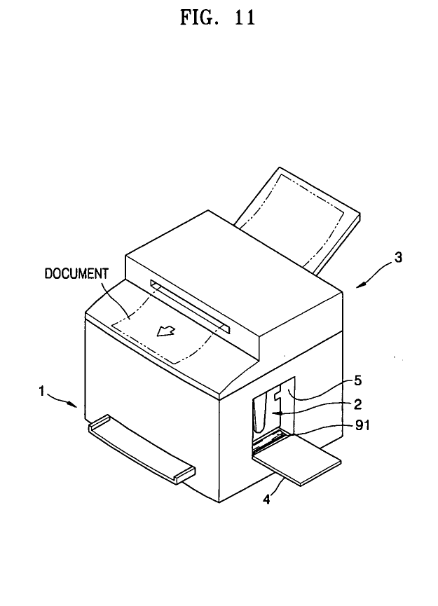

The image forming apparatus, as shown in FIGS. 10 and 11, may further comprise an image input unit 3 that reads an image from a document. The image input unit 3 is a document feeding type image input unit 11 (see FIG. 11) in which an image sensor (such as a contact type image sensor (CIS) or a charge coupled device (CCD)) is fixed and a document is moved, or a flat-bed type image input unit (see FIG. 10) in which the document is placed on a document stand 31 and the image sensor (not shown) is moved. The document feeding type image input unit and the flat-bed type image input unit are well known to one of ordinary skill in the art, and thus a detailed explanation thereof has been omitted. To reduce the area of the installed image forming apparatus, it is preferable that the image input unit 3 be installed on top of the body 1, particularly, when the flat-bed type image input unit 3 is employed. According to the image forming apparatus of the present embodiment, since the inkjet head 2 slides through the opening 5 formed at the side of the body 1, the inkjet head 2 can be easily mounted in and dismounted from the body 1 although the image input unit 3 is installed on top of the body 1.

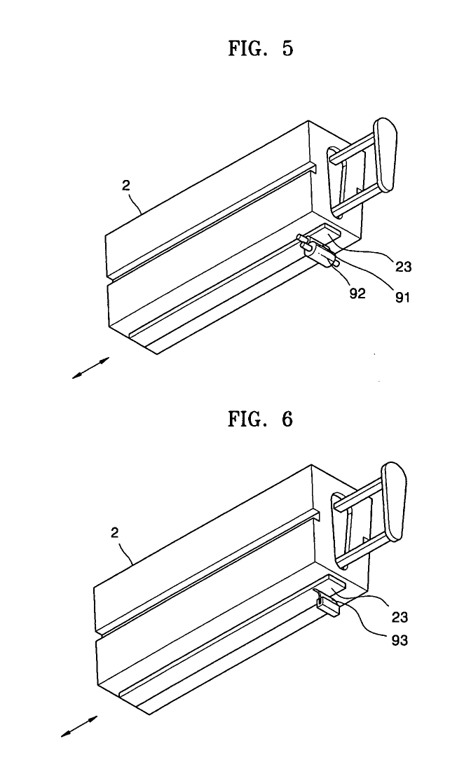

Referring to FIGS. 1, 2, and 5, the image forming apparatus may further comprise a wiping roller (wiping member) 91 that cleans the nozzle unit 23 of the inkjet head 2. The wiping roller 91 contacts the nozzle unit 23 and rotates when the inkjet head 2 is attached to and detached from the body 1. To this end, the wiping roller 91 is adjacent to the opening 5. Further, if the inkjet head 2 is completely mounted in the body 1, the wiping roller 91 is located such that it does not contact the nozzle unit 23. The image forming apparatus may further comprise a cleaning member 92 that contacts the wiping roller 91 and removes foreign substances collected on the wiping roller 91. Instead of the wiping roller 91, a wiping blade 93 elastically contacting the nozzle unit 23 can also be employed as shown in FIG. 6. In those constructions, while the inkjet head 2 is mounted and dismounted, the nozzle unit 23 can be cleaned. Alternatively, in a state where the inkjet head 2 is mounted in the body 1, the wiping member 91 or 93 or other wiping means can be moved in the main scanning direction M or in the sub scanning direction S by a moving means (not shown) to clean the nozzle unit 23 as well.

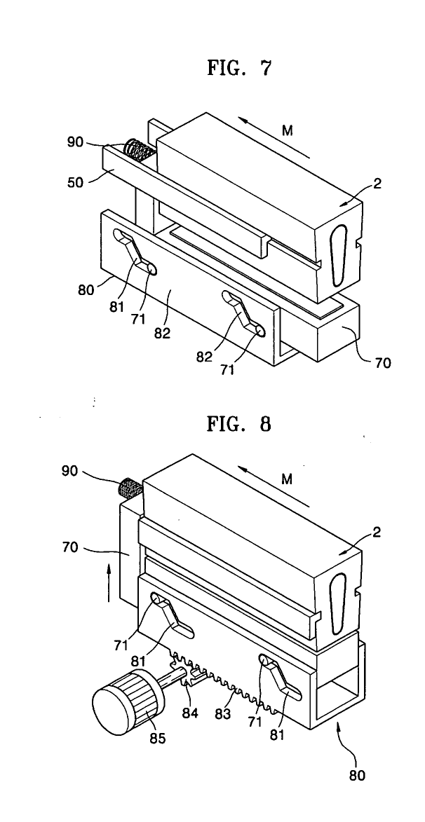

Referring to FIGS. 3 and 7, a cap member 70 is disposed on the body 1. The cap member 70 seals the nozzle unit 23 when the inkjet head 2 does not perform a printing operation, to prevent foreign substances from collecting on the nozzle unit 23 or preventing ink attached to the nozzle unit 23 from drying. When the inkjet head 2 is mounted, the cap member 70 is pushed by the inkjet head 2 to slide in the main scanning direction M. The cap member 70 is supported by a cam member 80. The cam member 80 comprises cam parts 81. The cam parts 81 are preferably slanted slots formed in the main scanning direction M on a side wall 82 of the cam member 80. Bosses 71 inserted into the cam parts 81 are formed on the cap member 70. An elastic member 90 provides an elastic force to the cap member 70 in a direction where the cap member 70 contacts the inkjet head 2.

When the inkjet head 2 is mounted in the body 1, the inkjet head 2 pushes the cap member 70 to cause the cap member 70 to slide in the main scanning direction M. Then, the cap member 70 is guided by the cam parts 81 to be lifted toward the nozzle unit 23. When the inkjet head 2 is placed on a mount position, the cap member 70 caps the nozzle unit 23 as shown in FIG. 8.

If the inkjet head 2 is removed from the body 1, the cap member 70 slides along the inkjet head 2 due to the elastic force of the elastic member 90 and is guided by the cam parts 81 to be lowered. The cap member 70 is spaced apart from the nozzle unit 23.

In the image forming apparatus of the present embodiment, there is no need to operate the cap member 70 to cap the nozzle unit 23 after the inkjet head 2 is mounted in the body 1 since the nozzle 23 can be capped automatically when the inkjet head 2 is mounted in the body 1. Furthermore, since the nozzle unit 23 can be uncapped automatically when the inkjet head 2 is removed from the body 1, there is no need to separate the cap member 70 from the nozzle unit 23 before the inkjet head 2 is removed from the body 1.

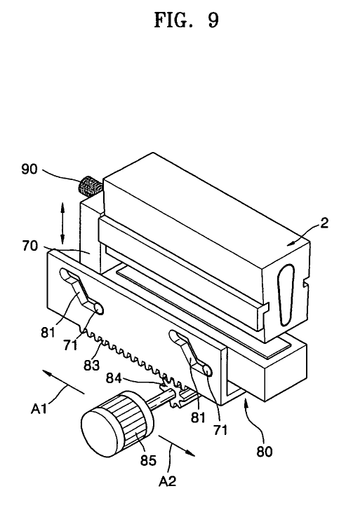

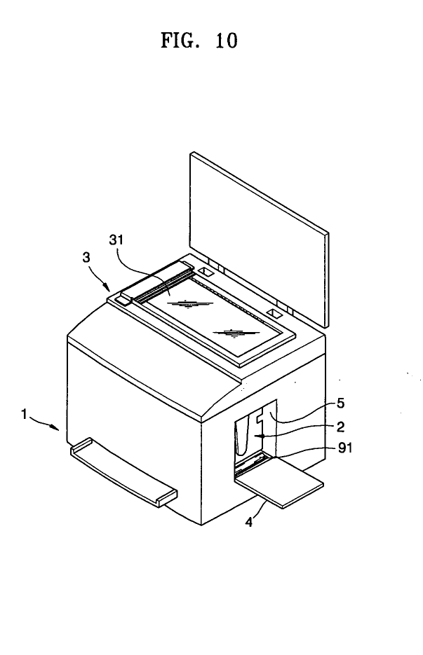

As described above, if the inkjet head 2 is mounted in the body 1, the cap member 70 caps the nozzle unit 23. To perform a printing operation, the nozzle unit 23 should be uncapped. To this end, the image forming apparatus employs an uncapping unit. For example, as shown in FIG. 8, the uncapping unit 90 may include a rack gear 83 disposed on the cam member 80, and a motor 85 including a pinion 84 that engages with the rack gear 83. Referring to FIG. 9, if the motor 85 rotates in a normal-direction, the cam member 80 slides in a direction marked by arrow A1. Then, the cap member 70 is guided by the cam parts 81 to be lowered, and the nozzle unit 23 is uncapped. If the printing operation is completed, the motor 85 rotates in a reverse direction. The cam member 80 slides in a direction marked by arrow A2 and returns to its original position as shown in FIG. 8. The cap member 70 is guided by the cam parts 81 to be lifted, and the nozzle unit 23 is capped.

As described above, the inkjet image forming apparatus according to an embodiment of the present invention has the following advantages.

First, since the inkjet head can slide in the main scanning direction into or out of one side of the body, the inkjet head can be easily mounted in and dismounted from the body. Also, since the image input unit can be installed on top of the body, the amount of desk space area occupied by the installed image forming apparatus can be reduced.

Second, since the first and second guide parts are employed, the inkjet head can be prevented from being damaged during mounting and dismounting of the inkjet head.

Third, since the cap member moves to a capping position and an uncapping position automatically when the inkjet head is mounted in and dismounted from the body, there is no need to move the cap member to the capping position and the uncapping position before the inkjet head is mounted and dismounted.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An inkjet image forming apparatus comprising:
a body having an opening formed at one side thereof;
an inkjet head comprising a nozzle unit with a length substantially corresponding to a width of a sheet of paper, the inkjet head sliding through the opening in a main scanning direction to be mounted in or removed from the body; and
a wiping member disposed on the body for contacting a nozzle unit of the inkjet head when the inkjet head is mounted in or removed from the body to clean the nozzle unit.

2. The inkjet image forming apparatus of claim 1, wherein the wiping member is adjacent to the opening.

3. The inkjet image forming apparatus of claim 1, wherein the wiping member is a wiping roller that rotates when contacting the nozzle unit.

4. The inkjet image forming apparatus of claim 3, further comprising a cleaning member contacting the wiping roller and removing foreign substances collected on the wiping roller.

5. The inkjet image forming apparatus of claim 1, wherein the wiping member is a wiping blade that elastically contacts the nozzle unit.

6. The inkjet image forming apparatus of claim 1, further comprising:
a cam member extending in the main scanning direction and having slanted cam parts;
a cap member pushed by the inkjet head to slide in the main scanning direction when the inkjet head is mounted in the body, and guided by the cam parts to cap the nozzle unit of the inkjet head; and
an elastic member providing an elastic force to the cap member in a direction where the cap member contacts the inkjet head.

7. The inkjet image forming apparatus of claim 6, further comprising an uncapping unit for sliding the cam member and moving the cap member to an uncapping position to allow a printing operation to be performed where the inkjet head is mounted in the body.

8. The inkjet image forming apparatus of claim 1, further comprising an image input unit installed on top of the body for reading an image from a document.

9. The inkjet image forming apparatus of claim 8, wherein the image input unit is one of a flat-bed type image input unit or a document feeding type image input unit.

10. A method of cleaning and capping a nozzle unit in the body of an image forming device, comprising the steps of:
guiding the insertion and removal of an inkjet head, wherein the inkjet head comprises a nozzle unit; and
cleaning the nozzle unit using a wiper member disposed on the body for contacting a nozzle unit of the inkjet head when the inkjet head is mounted in or removed from the body to clean the nozzle unit.

11. The method of claim 10, further comprising the steps of:
capping the nozzle unit with a capping member pushed by the inkjet head to slide in the main scanning direction when the inkjet head is mounted in the body, and guided by cam parts.
